(19) United States
(12) Patent Application Publication
(10) Pub. No.: US 2007/0169639 A1
(43) Pub. Date: Jul. 26, 2007

(54) Cooking element with removeable base for a steam cooker

(75) Inventor: Philippe Dumoux, Gemeaux (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 10/590,215

(22) PCT Filed: Feb. 23, 2005
(86) PCT No.: PCT/FR05/00425

§ 371 Date: Aug. 22, 2006

(30) Foreign Application Priority Data
Feb. 25, 2004 (FR) 0401899

(51) Int. Cl. A47J 37/12

(52) U.S. Cl. 99/403

(57) ABSTRACT

The invention relates to a cooking element which is intended for a steam cooker. The inventive element consist of a tubular lateral wall (1) and a removable perforated base (2), said tubular lateral wass (1) comprising an inner shoulder (10) which is designed to receive the perforated base (2). According to the invention, the perforated base (2) comprises an openwork plate (3) which is obtained by means of coated or non-coated metal sheet deformation.

The present invention concerns the technical field of steam cooking appliances.

Steam cookers have one or more cooking containers disposed on a steam producing base. The cooking containers have a perforated bottom permitting the steam to rise while passing around food disposed on the perforated bottom. The steam producing base may or may not have a self-contained water heating means.

To facilitate the serving of food, as well as cleaning, it is known from document WO 00/30511 to make a cooking element having a tubular side wall associated with a removable perforated bottom to form a cooking container.

Usually, this cooking element is made of polycarbonate. This polymeric material has the advantage of not being sensitive to staining. Certain foods, in particular carrots, stain in an indelible manner certain polymeric materials, such as for example polypropylene.

However, this material presents the disadvantage of undergoing hydrolysis as it is exposed to steam and during repeated passages in the dishwasher.

Moreover, the holes of the perforated bottom of this cooking element are relatively small and are difficult to clean.

The document WO 00/30511 certainly proposes to make the tubular side wall and the removable perforated bottom of stainless steel instead of polycarbonate, but does not propose a specific example of fabrication.

There is known from the US document U.S. Pat. No. 5,275,094 a cooking basket for a steam cooker having a bottom undulated in a radial direction. Oblong perforations are arranged in the hollows of the bottom. This arrangement prevents the food from coming in direct contact with the steam outlet and facilitates cleaning. However, the perforated bottom of this cooking basket is not removable. Moreover, the material used to fabricate this cooking basket is not specified.

There is known from document EP 0788 754 a cooking container and an interior cooking basket having a bottom presenting oblong perforations provided in depressed zones of the bottom. The oblong perforations are arranged in a radial way. The cooking container for example is made of a white polymeric material, such as polypropylene. The cooking container is used with foods releasing little or no colored pigments during their cooking. The interior cooking basket is made of a black polymeric material. The interior cooking basket is used with food releasing colored pigments during their cooking, such as carrots, sweet peppers, or red beets. However, the perforated bottom of the cooking container or the interior cooking basket is not removable.

A goal of the present invention is to propose an cooking element having a tubular side wall and a perforated removable bottom which prevents sticking of the food and which presents a better quality in use, in particular which avoids the phenomena of degradation due to hydrolysis or stains due to contact with foods.

Another goal of this invention is to propose a cooking element of the above mentioned type, in which cleaning is facilitated.

Another goal of this invention is to propose an cooking element of the above mentioned type, in which the tubular side wall and the perforated removable bottom present a retaining device.

Another goal of this invention is to propose an cooking element of the above mentioned type, whose construction remains economical.

These goals are achieved with a cooking element for a steam cooker, comprising a tubular side wall and a removable perforated bottom, the tubular side wall presenting an interior shoulder provided to receive the perforated bottom, by the fact that the perforated bottom comprises an openwork plate obtained by deformation of a metal sheet coated or not. This arrangment makes it possible to produce a perforated bottom in a matter easy to clean, not affected by food pigments, and resistant to detergent agents. The presence of a peripheral edge also can be avoided, such an edge being susceptible to hamper the transfer of food and/or to complicate the introduction of retaining elements cooperating with the tubular side wall. The openwork plate can be obtained by stamping and cutting of the perforations during the same operation. The openwork plate can in particular be made of coated aluminum.

Advantageously then, the tubular side wall is made of a material different from the material of the openwork plate. The operational constraints are not the same for the perforated bottom and the tubular side wall. The majority of food to be cooked rest on the perforated bottom, but only rarely touch the tubular side wall. Cleaning of the perforated bottom must thus be more thorough. Because of its compactness, the passage of the perforated bottom into the dishwasher is facilitated. On the contrary, the passage into the dishwasher of the tubular side wall, less dirty and more cumbersome, appears less necessary.

Advantageously then the tubular side wall is made of a transparent or translucent material. The tubular side wall can in particular be made of plastic, or glass.

More particularly, the openwork plate presents conformations arranged beyond from the periphery of the openwork plate. This arrangement contributes to the rigidity of the openwork plate and makes it possible to reduce the thickness of the openwork plate.

According to an advantageous embodiment, the conformations are arranged in a planar zone of the openwork plate. This arrangement simplifies fabrication of the openwork plate while allowing it to be rigidified. Alternatively, the entire surface of the openwork plate could be equipped with conformations.

Advantageously then, for a better rigidity of the openwork plate, the conformations occupy at least 30% of the surface of the openwork plate.

Advantageously still, the openwork plate has a central zone nearer to the center than to the edge of said openwork plate and any straight line passing though said central zone encounters at least one of the conformations.

This arrangement makes it possible to limit flexing of the openwork plate.

According to an advantageous embodiment, any straight line passing through said central zone encounters at least one of the conformations on both sides of said central zone.

Advantageously still the openwork plate is free of any peripheral annular edge and present along any radial section at least one conformation, at least one perforation being arranged in said conformation or in at least one of said conformations. This arrangement makes it possible to rigidify the openwork plate while allowing the passage of steam.

Preferably several perforations are provided in said conformation or conformations.

Advantageously still, the openwork plate is free of any annular peripheral edge and has a central zone nearer to the center than to the edge of said openwork plate, any straight line passing through said central zone encountering at least one conformation, at least one perforation being provided in said conformation or in at least one of said conformations. This arrangement also makes it possible to rigidify the openwork plate while allowing the passage of steam. Preferably, several perforations are provided in said conformation or conformations.

Advantageously then any straight line passing through said central zone encounters on both sides of said central zone said conformation or at least one of said conformations. This arrangement makes it possible to further rigidify the openwork plate while allowing the passage of steam.

Advantageously still, at least certain ones of the conformations are elongated. This arrangement makes it possible to reinforce the rigidity of the perforated plate.

This arrangement also makes it possible to accommodate more easily the perforations in said conformations. Alternatively, the conformation or conformations can in particular present a spiral form and/or a folded up form, and/or a branched form, and/or present elongated portions.

Advantageously then, at least certain ones of the elongated conformations are arranged circumferentially. This arrangement makes it possible to facilitate the rigidification of the openwork plate. Moreover the circumferential arrangement of said elongated conformations allows the use of a turning movement for manual cleaning, more common than radial movements, and thus contributes to facilitating cleaning. In the alternative, at least certain portions of said conformation or of said conformations can be arranged circumferentially or with an angle less than 30° relative to the circumferential direction.

Advantageously then, at least two series of said elongated conformations are arranged in an alternating manner. This arrangement makes it possible to improve the rigidification of the openwork plate. The presence of a planar zone along a radial direction can be avoided, such a planar zone promoting an irreversible deformation in flexure of the openwork plate.

Advantageously then, at least three series of said elongated conformations are arranged in an alternating manner.

Advantageously still, said conformation or at least certain ones of the conformations form one or more depressions. This arrangement makes it possible to limit or avoid contact of food with said conformation(s), and thus contributes to facilitating the serving of food. In the alternative, at least certain portions of said conformation or of said conformations can be depressions.

Advantageously then, perforations are arranged in the bottom of said depression or of at least certain of said depressions. The perforations arranged in said depression(s) facilitate the passage of steam, the food not being generally directly in contact with the perforations. This arrangement also facilitates cleaning. Said depression or each one of said depressions can have one or more perforations.

Advantageously, for a better diffusion of steam, each depression contains at least one of the perforations.

Advantageously, to facilitate cleaning and the diffusion of steam, at least certain ones of the perforations are elongated.

Advantageously, the ratio between the depth and the width of the depressions is less than 1, this arrangement making it possible to facilitate the fabrication of the openwork plate and to facilitate its cleaning. Preferably, the ratio between the depth and the width of the depressions are lower than 0.7.

According to one advantageous embodiment, parts presenting a retaining strip adapted to cooperate with a lower abutment of the tubular side wall are mounted on the openwork plate. This arrangement makes it possible to firmly attach the perforated bottom with the tubular side wall. The retaining strips can be rigid if the tubular side wall is flexible. The retaining strips can be flexible and/or mobiles if the tubular side wall is rigid.

Then, according to an advantageous arrangement, the parts come to be supported on the openwork plate and present arms engaged under the openwork plate. This arrangement makes it possible to facilitate the location of the retaining means. In the alternative, the parts can in particular be mounted under the openwork plate and to present arms that bear on the openwork plate.

Advantageously still, each part is installed in a peripheral depression of the openwork plate. This arrangement makes it possible to avoid protuberances on the surface, and to facilitate cleaning. The arms can be engaged in cutouts or under side edges of the openwork plate.

Advantageously still, each part has at least one recess in which the openwork plate is deformed to provide an anchor point. This arrangement makes it possible to assemble the parts and the openwork plate in a particularly economical manner. Moreover, such assembly renders cleaning of the perforated bottom easier than with an assembly by screws.

Advantageously still, the openwork plate has a peripheral conformation extending between the retaining strips. The peripheral conformation can be hollow and/or in relief. This arrangement makes it possible to further reinforce the rigidity of the openwork plate.

Advantageously still, the perforated bottom presents an elliptical geometry and has two retaining strips disposed in a diametrically opposed manner along the small diameter. This arrangement makes it possible to facilitate the withdrawal of the perforated bottom.

The invention will be better understood from a study of an example of realization, taken on a non-limiting basis, accompanied by alternatives, illustrated in the annexed figures, in which:

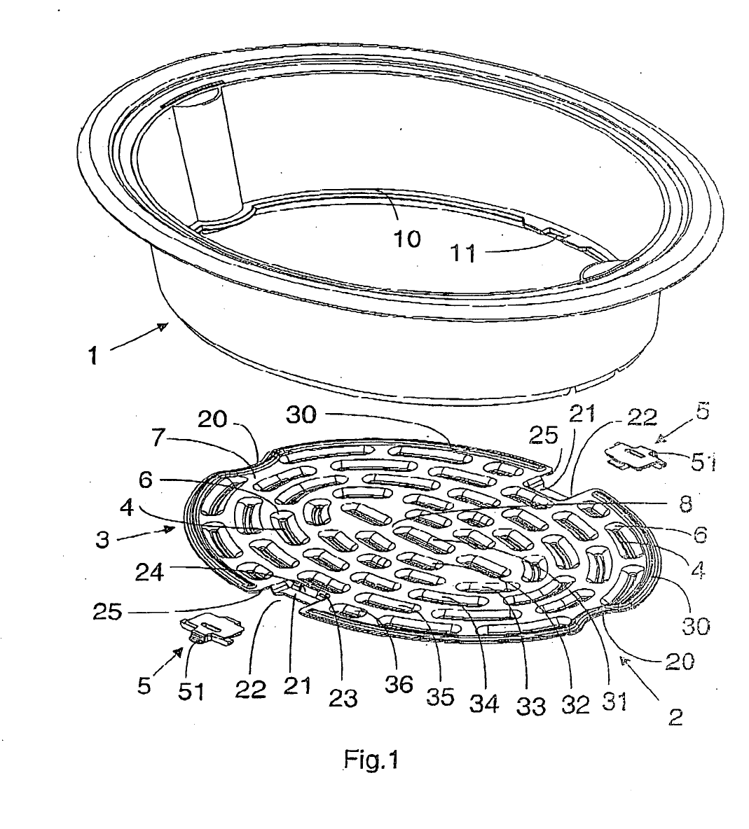

FIG. 1 is an exploded view of a cooking element according to the invention, having an annular side wall and a perforated removable bottom,

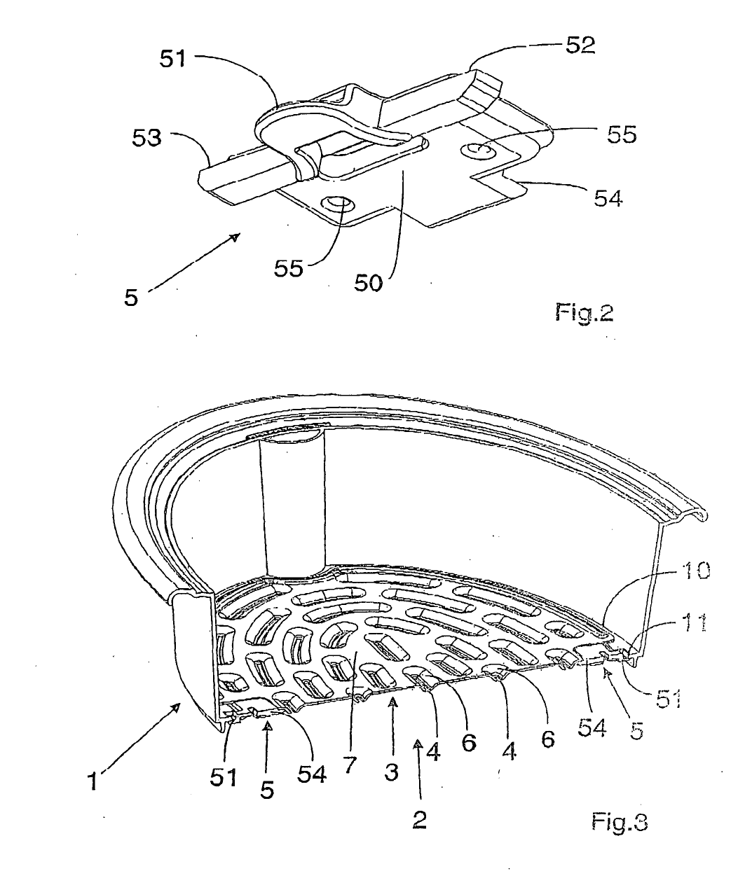

FIG. 2 is an enlarged view one of the attachment bodies of the perforated removable bottom,

FIG. 3 is a perspective, cross-sectional view showing the attachment of the removable perforated bottom to the annular side wall.

FIG. 1 illustrates a cooking element for a steam cooker, according to the invention. The cooking element comprises a tubular side wall 1 and a removable perforated bottom 2.

The tubular side wall 1 presents an interior shoulder 10 provided to receive the perforated bottom 2. The interior shoulder 10 extends over all of the circumference of the tubular side wall 1. As an alternative, the interior shoulder can be discontinuous.

The perforated bottom 2 comprises two retaining strips 51 adapted to cooperate with a lower abutment 11 of the tubular side wall 1. The perforated bottom 2 presents an elliptical geometry. The two retaining strips 51 are disposed in a diametrically opposite manner along the small diameter. As an alternative, the perforated bottom 2 can be free of retaining strips 51, or have more than two retaining strips.

The perforated bottom 2 comprises an openwork plate 3 provided with perforations 4. Parts 5 are assembled on the openwork plate 3. Each part 5 presents one of the retaining strips 51.

As an alternative, the retaining strips could be part of the openwork plate. As and alternative, other geometries can be envisioned for the perforated bottom 2 and the tubular side wall 1.

The openwork plate 3 is obtained by deformation of a metal sheet coated or not. The openwork plate 3 for example is made of stainless steel, or aluminum coated with a non-stick surface layer, such as for example a lacquer or PTFE. If desired, coating of the openwork plate 3 can be partial, for example limited to the upper face of the openwork plate 3.

The openwork plate 3 is advantageously formed starting from a thin sheet. The thickness of the sheet is advantageously smaller than 1.5 mm in the case of coated aluminum (for example ranging between 1 mm and 1.5 mm), and advantageously smaller than 1 mm in the case of stainless steel (for example ranging between 0.6 mm and 1 mm).

The tubular side wall 1 is advantageously formed of a material different from the material of the openwork plate 3. The tubular side wall 1 can be made of a transparent or translucent material, for example of glass or plastic. The tubular side wall 1 can in particular be made of polycarbonate.

The openwork plate 3 presents an elliptical geometry, with two side notches 20 arranged along the large diameter, and two peripheral depressions 21 arranged along the small diameter. The peripheral depressions 21 also provide side notches 22. Each peripheral depression 21 has a side wall 23 presenting a frontal opening 24. The side notches 22 provide side edges 25 in the openwork plate 3.

As is clearly shown in FIG. 1, the openwork plate 3 is free of an annular peripheral edge. This arrangement is unfavorable for the rigidity of the openwork plate. However, the peripheral depressions 21 contribute locally to the rigidity of the openwork plate 3. Moreover, the contours of the openwork plate contribute to the rigidity of the openwork plate 3.

The openwork plate 3 has the conformations 30, 31, 32, 33, 34, 35, 36 arranged spaced from the periphery of the openwork plate 3. Conformations 30, 31, 32, 33, 34, 35, 36 allowing to improve the rigidity and to reduce the thickness of said plate. Conformations 30, 31, 32, 33, 34, 35, 36 are arranged in a planar zone of the openwork plate 3. Conformations 30, 31, 32, 33, 34, 35, 36 occupy at least 30% of the surface of the openwork plate 3. Conformations 30, 31, 32, 33, 34, 35, 36 are arranged in a planar zone 7 of the openwork plate 3.

The openwork plate 3 has two conformations 30 extending close to the edge to the openwork plate between the retaining strips 51. Conformations 30 are elongated and designed to rigidify the edge of the openwork plate 3. Conformations 30 form a convex relief. Conformations 30 extend at a distance from the edge of the openwork plate 3. The height of conformations 30 is for example of 1.5 mm. As an alternative, the openwork plate 3 can have several conformations 30 extending between the retaining strips 51. As an alternative, conformations 30 could present a relief at least partially concave. As an alternative, conformations 30 could be omitted or be replaced by one or more portions of nonannular peripheral edge.

Conformations 31, 32, 33, 34, 35, 36 are elongated. Conformations 31, 32, 33, 34, 35, 36 are divided into several series. Conformations 31 of the first series are three in number and are arranged along the large axis of the ellipse. The central conformation 31 is longer than the width of the side notches 22, for a better rigidity of the openwork plate 3. Conformations 32 of the second series are four in number and are laid out in pairs at one side and the other of conformations 31, in a circumferential manner. Conformations 32 are thus slightly curved. Conformations 33 of the third series are ten in number and are arranged circumferentially around conformations 32. Conformations 34 of the fourth series are ten in number and are arranged circumferentially around conformations 33. Conformations 35 of the fifth series are twelve in number and are arranged circumferentially around conformations 34. Conformations 36 of the sixth series are twelve in number and are arranged circumferentially around conformations 35, three conformations 36 being disposed between each side notch 20 and each side notch 22. Elongated conformations 33, 34, 35, 36 are slightly curved.

The openwork plate 3 presents at least two series of elongated conformations 33, 34, 35 arranged circumferentially and in an alternating manner. In other words, a radial section of the openwork plate 3 encounters at least one of the series of elongated conformations 33, 34, 35, whatever the orientation of this section. This arrangement makes it possible to rigidify the openwork plate 3 and thus to avoid the risk of deforming in an irreversible way the openwork plate 3 during handling, or having a too flexible plate not supporting the weight of the food. More particularly, the openwork plate 3 presents three series of elongated conformations 33, 34, 35 arranged circumferentially and in an alternating manner.

Thus, the openwork plate 3 has a central zone 8 closer to the center than to the edge of said openwork plate, any straight line passing through said central zone 8 encountering at least one of the conformations 30, 31, 32, 33, 34, 35, 36. More particularly, any straight line passing through said central zone 8 encounters at least one of the conformations 30, 31, 32, 33, 34, 35, 36 at one side and the other of said central zone 8.

Thus, such as is clearly shown in FIG. 1, the openwork plate 3 is free of a peripheral edge annular and presents along any radial section at least one of the conformations 30, 31, 32, 33, 34, 35, 36. A perforation 4 is provided in each of the conformation 31, 32, 33, 34, 35, 36. Conformations 30, 31, 32,33, 34,35, 36 are elongated. Conformations 31, 32, 33 are arranged circumferentially. Thus, the openwork plate 3 has along any diametrical section at least two elongated conformations arranged at one side and the other of the center of the openwork plate 3, contributing effectively to its rigidification.

Elongated conformations 31, 32, 33, 34, 35, 36 are depressions 6. Perforations 4 are provided in the bottom of depressions 6. As an alternative, certain ones of the conformations can be at least partially concave, at least certain of the conformations then being depressions. Perforations are then provided in the bottom of at least certain ones of the depressions. As an alternative, each depression can have at least one of the perforations. Preferably, all of the perforations are provided in the bottom of depressions 6.

In the example of realization proposed, the depth of depressions 6 is about 3.5 to 4 mm, and the width of depressions 6 is about 7 mm. The ratio between the depth and the width of the depressions is about 0.5 to 0.6. As an alternative, other proportions can be envisioned, with advantageously a ratio lower than 1, and preferably lower than 0.7, to facilitate cleaning of depressions 6.

Perforations 4 are elongated. As an alternative, preferably at least certain ones of perforations 4 are elongated.

The parts 5, one of which is illustrated on FIG. 2, have a body 50 provided to be placed in one of the peripheral depressions 21, a retaining strip 51 adapted to cooperate with a lower abutment 11 of the tubular side wall 1, arms 52, 53 provided to be engaged under the side edges 25 of the openwork plate 3, an arm 54 provided for be engaged in the frontal opening 24.

Thus parts 5 come to bear on the openwork plate 3, and present arms 52, 53, 54 engaged under the openwork plate 3. Each part 5 is placed in one of the peripheral depressions 21 of the openwork plate 3.

Body 50 has two recesses 55 in which the openwork plate 3 is deformed to create an anchor point. As an alternative, each part 5 has at least one recess 55 in which the openwork plate 3 is deformed to create an anchor point. As an alternative, other assembly means can be used.

FIG. 3 illustrates one of parts 5 mounted on the openwork plate 3 placed in the tubular side wall 1. The openwork plate 3 rests on the interior shoulder 10 of the tubular side wall 1. The retaining strip 51 cooperates with the lower abutment 11 of the tubular side wall 1.

To withdraw the perforated bottom 2 removable of the tubular side wall 1, the user exerts a pulling force on the tubular side wall 1 along the small diameter in order to release the retaining strips 51 from the lower abutments 11.

Fabrication of the openwork plate 3 can be carried out in particular by stamping. Peripheral conformations 30, elongated conformations 31, 32, 33, 34, 35, 36 and the peripheral depressions 21 can be obtained during this operation. The perforations 4 and/or frontal openings 24 can be advantageously obtained at the time of this same operation. Parts 5 can be fixed to the openwork plate 3 during a striking operation, for example after the stamping operation. The manufacture of the perforated bottom 2 is thus particularly economical.

Moreover care of the perforated bottom 2 is particularly easy, thanks to the weak adherence of food on the surface of the openwork plate 3, and thanks to the arrangement and to the geometry of the perforations 4 which avoids direct contact of the perforated zones with most of the food. Perforations 4 arranged in conformations 31, 32, 33, 34, 35, 36 forming depressions 6 avoid the adherence of food at the level of perforations 4.

Moreover, the quality of cooking is aided by the large surface of perforations 4, as well as by their distribution on the perforated bottom 2.

As an alternative, conformations 31, 32, 33, 34, 35, 36 could present other geometries, in particular circular or even cruciform.

As an alternative, at least one of the series of conformations 30, 31, 32, 33, 34, 35, 36 could be replaced by an annular conformation having at least one perforation 4.

As an alternative, the openwork plate 3 can have one or more peripheral edge portions extending upward and/or downward, forming one or several conformations. However, such a peripheral edge is not annular.

As an alternative, at least one of the conformations 31; 32; 33; 34; 35; 36 can present one perforation 4.

As an alternative, at least one of the conformations 30 could present one or more perforations and/or form a depression.

As an alternative, the conformations of two adjacent series, for example conformations 33 of the third series and conformations 34 of the fourth series, and/or conformations 34 of the fourth series and conformations 35 of the fifth series could be arranged so as to meet and form a conformation presenting a spiral form and/or a folded form, and/or a branched form.

As an alternative, the openwork plate could present along any radial section a conformation presenting a spiral form and/or a folded form, and/or a branched form, one or more perforations being provided in said conformation.

As an alternative, some of the conformations 30, 31, 32, 33, 34, 35, 36 of the openwork plate could meet to form one or several conformations having a form branched or not, certain conformation portions being advantageously elongated and/or arranged circumferentially.

As an alternative, certain conformation portions could be arranged circumferentially or with an angle less than 30° with respect to the circumferential direction.

As an alternative, at least certain portions of said conformation or of said conformations can be depressions.

The present invention is by no means limited to the example of realization described and its alternatives, but includes many modifications within the framework of the claims.

1. Cooking element for a steam cooker comprising a tubular side wall (1) and a removable perforated bottom (2), the tubular side wall (1) presenting an interior shoulder (10) provided to receive the perforated bottom (2), characterized in that the perforated bottom (2) comprises an openwork plate (3) obtained by deformation of a metal sheet coated or not.

2. Cooking element for a steam cooker according to claim 1, characterized in that the tubular side wall (1) is made of a material different from the material of the openwork plate (3).

3. Cooking element for a steam cooker according to claim 2, characterized in that the tubular side wall (1) is made of a transparent or translucent material.

4. Cooking element for a steam cooker according to claim 3, characterized in that the tubular side wall (1) is made of plastic.

5. Cooking element for a steam cooker according to claim 3, characterized in that the tubular side wall (1) is made of glass.

6. Cooking element for a steam cooker according to claim 1, characterized in that the openwork plate (3) is free of any peripheral annular edge and present along any radial section at least one conformation (30, 31, 32, 33, 34, 35, 36), at least one perforation (4) being arranged in said conformation or in at least one (31, 32, 33, 34, 35, 36) of said conformations.

7. Cooking element for a steam cooker according to claim 1, characterized in that the openwork plate (13) is free of any annular peripheral edge and has a central zone (8) nearer to the center than to the edge of said openwork plate (3), in that any straight line passing through said central zone (8) encounters at least one conformation (30, 31, 32, 33, 34, 35, 36), at least one perforation (4) being provided in said conformation or in at least one (31, 32, 33, 34, 35, 36) of said conformations.

8. Cooking element for a steam cooker according to claim 7, characterized in that any straight line passing through said central zone (8) encounters on both sides of said central zone (8) said conformation or at least one of said conformations (30, 31, 32, 33, 34, 35, 36).

9. Cooking element for a steam cooker according to claim 6, characterized in that at least certain ones of the conformations (30, 31, 32, 33, 34, 35, 36) are elongated.

10. Cooking element for a steam cooker according to claim 9, characterized in that at least certain ones of the elongated conformations (30, 33, 34, 35) are arranged circumferentially.

11. Cooking element for a steam cooker according to claim 10, characterized in that at least two series of said elongated conformations (33, 34, 35) are arranged in an alternating manner.

12. Cooking element for a steam cooker according to claim 11, characterized in that at least three series of said elongated conformations (33, 34, 35) are arranged in an alternating manner.

13. Cooking element for a steam cooker according to claim 6, characterized in that said conformation or at least certain ones of said conformations (31, 32, 33, 34, 35, 36) form one or more depressions (6).

14. Cooking element for a steam cooker according to claim 13, characterized in that the perforations (4) are arranged in the bottom of said depression or of at least certain of said depressions (6).

15. Cooking element for a steam cooker according to claim 14, characterized in that each depression (6) contains at least one of the perforations (4).

16. Cooking element for a steam cooker according to claim 14, characterized in that at least certain ones of the perforations (4) are elongated.

17. Cooking element for a steam cooker according to claim 1, characterized in that parts (5) presenting a retaining strip (51) adapted to cooperate with a lower abutment (11) of the tubular side wall (1) are mounted on the openwork plate (3).

18. Cooking element for a steam cooker according to claim 17, characterized in that the parts (5) come to be supported on the openwork plate (3) and present arms (52, 53, 54) engaged under the openwork plate (3).

19. Cooking element for a steam cooker according to claim 17, characterized in that each part (5) is installed in a peripheral depression (21) of the openwork plate (3).

20. Cooking element for a steam cooker according to claim 17, characterized in that each part (5) has at least one recess (55) in which the openwork plate (3) is deformed to provide an anchor point.

21. Cooking element for a steam cooker according to claim 17, characterized in that the openwork plate (3) has a peripheral conformation (30) extending between the retaining strips (51).

22. Cooking element for a steam cooker according to claim 17, characterized in that the perforated bottom (2) presents an elliptical geometry and in that it has two retaining strips (51) disposed in a diametrically opposed manner along the small diameter.
